(19) United States
(12) Patent Application Publication
(10) Pub. No.: US 2016/0229321 A1
(43) Pub. Date: Aug. 11, 2016

(54) PORTABLE HEAD REST COVER

(71) Applicant: Jesse Kamekona, Long Beach, CA (US)

(72) Inventor: Jesse Kamekona, Long Beach, CA (US)

(21) Appl. No.: 14/615,558

(22) Filed: Feb. 6, 2015

(51) Int. Cl. B60N 2/60; A47C 31/00

(52) U.S. Cl. CPC B60N 2/60; A47C 31/007

(57) ABSTRACT

A method for providing bacterial protection for a head rest comprising the steps of: transporting a portable head rest cover, where the head rest cover is made of a flexible material; covering a head rest of a high back seat with the portable head rest cover during use of the high back seat; removing the portable head rest cover from the high back seat; and storing the portable head rest cover for future use. In one particular embodiment, the flexible material is spandex acrylic and the portable headrest cover may include an inside pocket. The method of providing bacterial may further include removing an anti-bacterial wipe from the inside pocket for use on the high back seat. The high back seat includes at least one of an airplane seat, a bus seat, a train seat and a theater seat.

### BACKGROUND OF THE INVENTION

1. Field of Invention

The present invention relates to a portable head rest cover and a method of use thereof that is placed over public seating such as seats on an airplane, train, bus or in a theater.

2. Description of Related Art

Public seating is available in various venues. Typically public transportation seats are available that include headrests such as on airplanes, buses or trains. Further any public seat that includes a high back with a headrest creates a unique exposure and hygiene problem for the general public. Since these seats are used by numerous individuals at various times germs through sweat and skin contact may be present on the headrest. Presently there are limited options for the public to limit exposure to these germs while sitting in public seating. As a consequence, it would be advantageous to have a device that could be used by an individual to cover the head rest area of such high back seats that are used in public transportation and theaters to reduce the transfer of germs and sweat that may exist on the head rest area.

### SUMMARY OF THE INVENTION

The present invention relates to a method for providing bacterial protection for a head rest comprising the steps of: transporting a portable head rest cover, where the head rest cover is made of a flexible material; covering a head rest of a high back seat with the portable head rest cover during use of the high back seat; removing the portable head rest cover from the high back seat; and storing the portable head rest cover for future use. In one particular embodiment, the flexible material is spandex acrylic and the portable headrest cover may include an inside pocket. The method of providing bacterial may further include removing an anti-bacterial wipe from the inside pocket for use on the high back seat. The high back seat includes at least one of an airplane seat, a bus seat, a train seat and a theater seat.

### BRIEF DESCRIPTION OF DRAWINGS

FIG. 1 depicts use of a seat head cover in accordance with the present invention.

### DETAILED DESCRIPTION

The present invention relates to a seat head cover that is portable for individual use. The head cover according to present invention is a spandex acrylic material that is stretched over the head rest area of a public seat. The seat head cover is easily foldable and then placed in a carrying bag provided for the individual to use as needed.

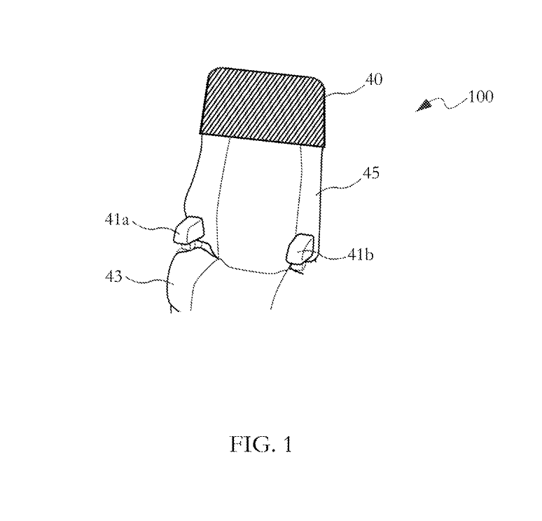

In reference to FIG. 1, a public seat 100 is depicted. This public seat includes a backrest 45, arm rests 41a, 41b, a seat area and a head portion of the back rest 45. The arrangement shown includes a portable head cover 40 that is placed over the head portion of the backrest 45. This portable expandable head cover 40 may used by an individual to eliminate the transfer of germs or debris that may exist on a public seat. The head cover 40 is simply placed over the head support area to prevent the transference of germs and or bacteria. In one particular embodiment, this head cover may be embossed with various customized logos or other esthetic aspects in order to provide an individualized look for the head cover. Further, the head cover may include a pocket on the inside surface, not shown, where the pocket stores anti-bacterial wipes. A user may use the wipes to wipe off any surface such as the arm rests 41a, 41b or tray tables. Also in another exemplary embodiment, the head cover may include an opening in the rear panel. Such an opening could accommodate seat backs that include video monitors, so that the monitor is visible during use of the head cover. The instant invention has been shown and described in what it considers to be the most practical and preferred embodiments. It is recognized, however, that departures may be made there from within the scope of the invention and that obvious modifications will occur to a person skilled in the art.

What is claimed is:

1. A method for providing bacterial protection for a head rest comprising the steps of:
a. transporting a portable head rest cover, where the head rest cover is made of a flexible material;
b. covering a head rest of a high back seat with the portable head rest cover during use of the high back seat;
c. removing the portable head rest cover from the high back seat; and
d. storing the portable head rest cover for future use.

2. The method of providing bacterial protection according to claim 1, where the flexible material is spandex acrylic.

3. The method of providing bacterial protection according to claim 1, where the portable head rest cover includes an inside pocket.

4. The method of providing bacterial protection according to claim 3, further comprising removing an anti-bacterial wipe from the inside pocket for use on the high back seat.

5. The method of providing bacterial protection according to claim 1, where the high back seat includes at least one of an airplane seat, a bus seat, a train seat and a theater seat.
